(19) United States
(12) Patent Application Publication
(10) Pub. No.: US 2007/0081619 A1
(43) Pub. Date: Apr. 12, 2007

(54) Clock generator and clock recovery circuit utilizing the same

(75) Inventors: Chun-Cheng Kuo, Taipei City (TW); Tun-Shih Chen, Pingtung County (TW); Li-Ren Huang, Taipei County (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/440,001

(22) Filed: May 25, 2006

(30) Foreign Application Priority Data
Oct. 7, 2005 (TW) 94135183

(51) Int. Cl. H04L 7/00

(52) U.S. Cl. 375/371

(57) ABSTRACT

A clock generator including an edge detector, an oscillator, a frequency divider, and a selector. The edge detector generates a detection signal according to an edge of a data signal. The oscillator generates a first clock according to a control signal and controls the phase of the first clock according to the detection signal. The frequency divider processes the first clock to generate a second clock and is reset by the detection signal. The selector selectively outputs the first clock or the second clock according to an external signal.

### BACKGROUND OF THE INVENTION

1. Field of the Invention

The present invention relates to a clock generator, and in particular relates to a clock generator utilized in a clock recovery circuit.

2. Description of the Related Art

In a typical communication system, a transmitter generates data signals according to its clock and transmits the data signals to a receiver through channels. To correctly interpret the data signals, the receiver reads the data signals according to a clock synchronized with the clock of the transmitter. The receiver thus requires a clock recovery system to recover the data signal from the transmitter.

At least two clock recovery techniques are currently used. First, the clock of the transmitter may be transmitted to the receiver on a channel parallel with the channel carrying the data signals. The receiver can then estimate the phase of the data signals from the phase of clock of the transmitter. This technique however, is disadvantageous in that it requires an additional channel. Alternately, the phase of the data signals may be recovered directly from information carried in the data signals themselves.

FIG. 1 shows a conventional clock recovery circuit. The clock recovery circuit 10 comprises a clock generator 11 and a sampling circuit 12. Clock generator 11 generates a clock signal CK according to an edge of a data signal DIN. Clock signal CK synchronizes with the data signal DIN. To determine the logic level of the data signal DIN, sampling circuit 12 samples the data signal DIN according to the clock signal CK.

Clock generator 11 comprises an edge detector 111 and an oscillator 112. Edge detector 111 generates a control signal S1 according to the edge of the data signal DIN. Oscillator 112 generates the clock signal CK according to the control signal S1 and controls the phase of the clock signal CK according to a control voltage VC1. Therefore, the clock signal CK synchronizes with the data signal DIN.

However, since the communication system comprises data signals with various transmission speeds, clock generators are required for generating clock signals with various frequencies.

### BRIEF SUMMARY OF THE INVENTION

Clock generators are provided. An exemplary embodiment of a clock generator comprises an edge detector, an oscillator, a frequency divider, and a selector. The edge detector generates a detection signal according to an edge of a data signal. The oscillator generates a first clock according to a control signal and controls the phase of the first clock according to the detection signal. The frequency divider processes the first clock to generate a second clock and is reset by the detection signal. The selector selectively outputs the first clock or the second clock according to an external signal.

Another exemplary embodiment of a clock generator comprises an edge detector, an oscillator, a frequency divider, and a selector. The edge detector generates a detection signal according to an edge of a data signal. The oscillator generates a first clock according to a control signal and controls phase of the first clock according to the detection signal. The frequency divider processes the first clock to generate a second clock and a third clock and is reset by the detection signal. The selector selectively outputs the second clock or the third clock according to an external signal.

Clock recovery circuits are also provided. An exemplary embodiment of a clock recovery circuit comprises an edge detector, an oscillator, a frequency divider, a selector, and a sampling circuit. The edge detector generates a first detection signal according to an edge of a data signal. The oscillator generates a first clock according to a control signal and controls phase of the first clock according to the first detection signal. The frequency divider processes the first clock to generate a second clock and is reset by the detection signal. The selector selectively outputs the first clock or the second clock according to an external signal. The sampling circuit samples the data signal according to a signal output from the selector.

Another exemplary embodiment of a clock recovery circuit comprises an edge detector, an oscillator, a frequency divider, a selector, and a sampling circuit. The edge detector generates a first detection signal according to an edge of a data signal. The oscillator generates a first clock according to a control signal and controls phase of the first clock according to the first detection signal. The frequency divider processes the first clock to generate a second clock and a third clock and is reset by the detection signal. The selector selectively outputs the second clock or the third clock according to an external signal. The sampling circuit samples the data signal according to a signal output from the selector.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a conventional clock recovery circuit;

FIG. 2a is a schematic diagram of an exemplary embodiment of a clock recovery circuit;

FIGS. 2b and 2c are timing diagrams of the clock recovery shown in FIG. 2a;

FIG. 3a is a schematic diagram of another exemplary embodiment of a clock recovery circuit;

FIGS. 3b and 3c are timing diagrams of the clock recovery shown in FIG. 3a;

FIG. 4a is a schematic diagram of another exemplary embodiment of a clock recovery circuit;

FIGS. 4b and 4c are timing diagrams of the clock recovery shown in FIG. 4a; and

FIG. 5 is a schematic diagram of another exemplary embodiment of a clock recovery circuit.

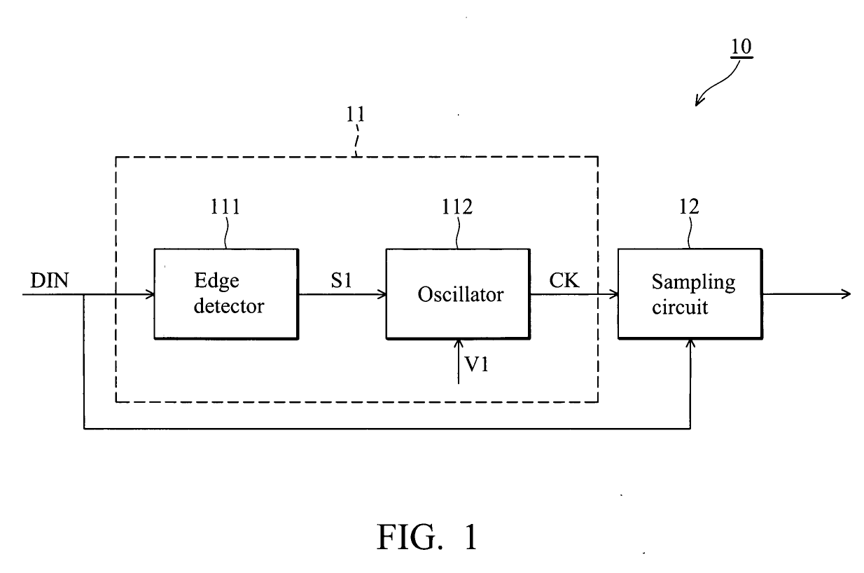

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

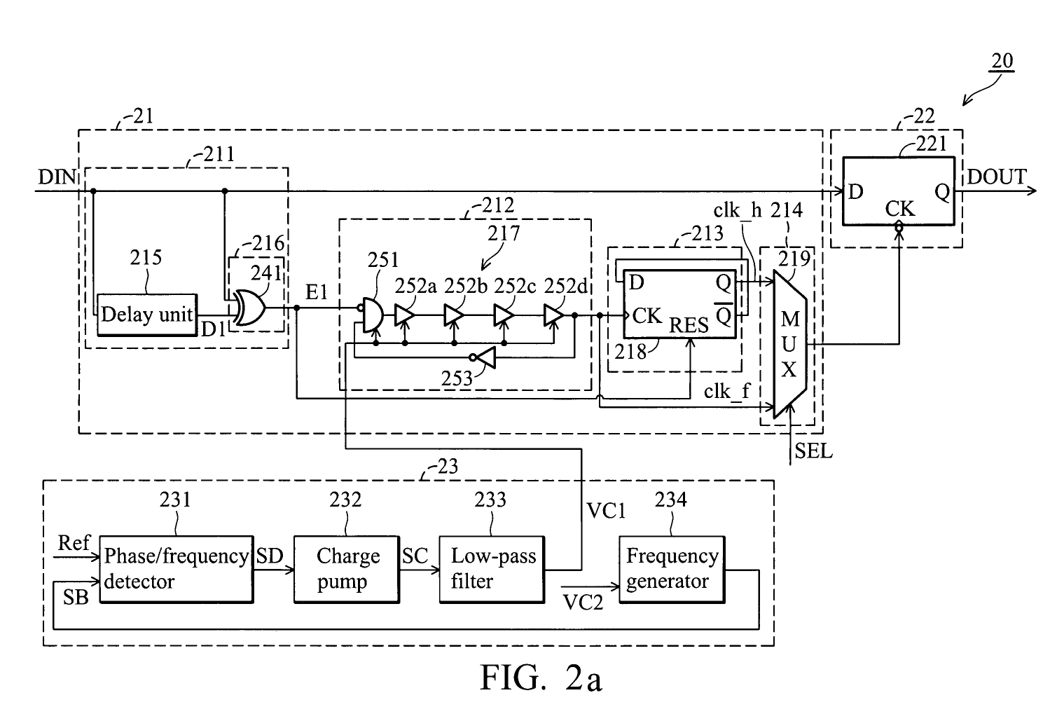

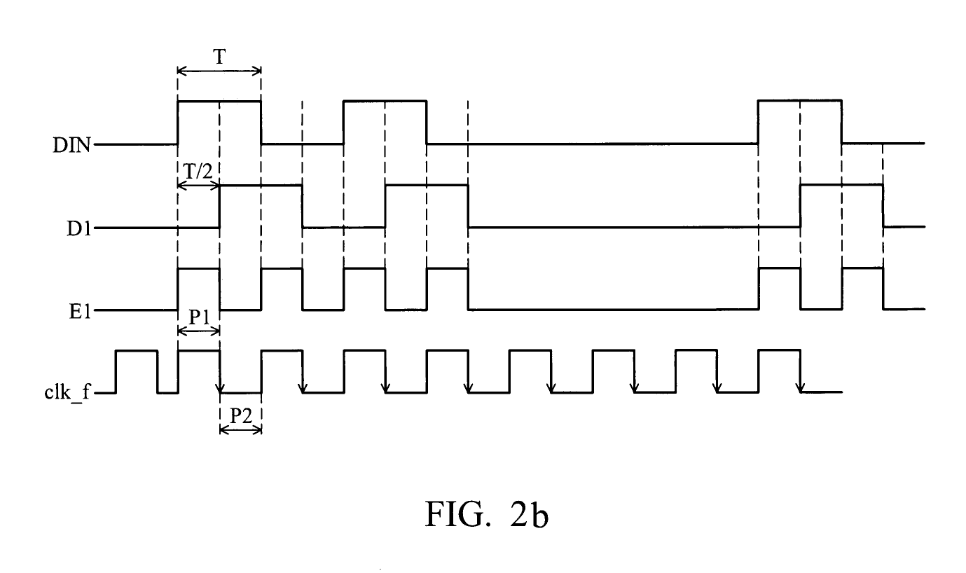

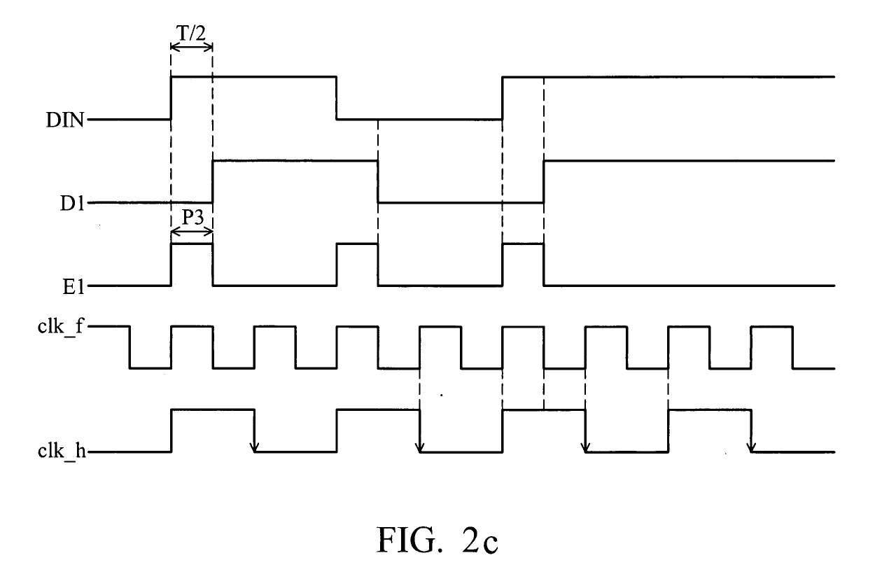

FIG. 2a is a schematic diagram of an exemplary embodiment of a clock recovery circuit. The clock recovery circuit 20 comprises a clock generator 21 and a sampling circuit 22. Clock generator 21 comprises an edge detector 211, an oscillator 212, a frequency divider 213, and a selector 214.

Edge detector 211 generates a detection signal El according to an edge of the data signal DIN. In this embodiment, edge detector 211 comprises a delay unit 215 and a processor 216. Delay unit 215 delays the data signal DIN to generate a delay signal D1. Processor 216 controls a voltage level of the detection signal E1 according to the data signal DIN and the delay signal D1

The voltage level of the detection signal E1 is a first voltage level when a voltage level of the data signal DIN is equal to that of the delay signal D1. The voltage level of the detection signal E1 is a second voltage level when the voltage level of the data signal DIN differs that of the delay signal D1. In this embodiment, processor 216 is a XOR gate 241, the first voltage level is a low voltage level, and the second voltage level is a high voltage level.

Oscillator 212 generates a clock clk_f according to a control signal VC1 and controls a phase of a clock clk_h according to the detection signal E1. In this embodiment, oscillator 212 is a Gated Voltage Controlled Oscillator (GVCO) 217.

GVCO 217 comprises logic gates 251, 253 and buffers 252a˜252d. The control signal VC1 controls the delay time of logic gate 251 and buffers 252a˜252d for controlling frequency of the clock clk_f. In this embodiment, GVCO 217 comprises four buffers 252a˜252d, but the disclosure is not limited thereto. The operation of a GVCO is well known to those skilled in the art, thus, description thereof is omitted.

Frequency divider 213 receives the detection signal E1 and the clock clk_f for processing the clock clk_f and generating the clock clk_h. Frequency divider 213 is reset by the detection signal E1. In this embodiment, frequency divider 213 is a D-type flip-flop 218. Thus, the frequency of the clock clk_f is double that of the clock clk_h.

D-type flip-flop 218 comprises a data input terminal D, a clock terminal CK, a reset terminal RES, an output terminal Q, and an inverse output terminal Q̅. Data input terminal D is coupled to the inverse output terminal Q̅. Clock terminal CK receives the clock clk_f. Reset terminal RES receives the detection signal E1. Output terminal Q outputs the clock clk_h.

When a voltage level of the clock clk_f is transformed from a low voltage level into a high voltage level, D-type flip-flop 218 is triggered such that output terminal Q outputs a signal received by data input terminal D.

Selector 214 selectively outputs the clock clk_f or the clock clk_h according to an external signal SEL. In this embodiment, selector 214 is a multiplexer 219.

Sampling circuit 22 samples the data signal DIN according to a signal output from selector 214. In this embodiment, sampling circuit 22 is a D-type flip-flop 221. D-type flip-flop 221 comprises a data input terminal D receiving the data signal DIN, a clock terminal CK receiving the signal output from selector 214, a output terminal Q output a response signal DOUT synchronized with the data signal DIN.

When the logic level of the signal output from selector 214 is transformed from high logic level into low logic level, D-type flip-flop 221 is triggered such that the output terminal Q of D-type flip-flop 221 outputs a signal received by data input terminal D of D-type flip-flop 221.

In some embodiments, the control signal VC1 received by oscillator 212 is generated by a Phase Locked Loop (PLL) 23. PLL 23 comprises a phase/frequency detector 231, a charge pump 232, a low-pass filter 233, and a frequency generator 234.

Phase/frequency detector 231 outputs a detection signal SD according to the difference between a reference frequency Ref and a feedback signal SB. Charge pump 232 receives the detection signal SD to generate a charge/discharge signal SC. Low-pass filter 233 filters a high frequency element of the charge/discharge signal SC to generate a control signal VC1. Frequency generator 234 controls frequency of the feedback signal SB according to a control signal VC2.

FIGS. 2b and 2c are timing diagrams of the clock recovery shown in FIG. 2a. In FIG. 2b, the transmission speed of the data signal DIN is 2.5G bps (billions of bit per second) such that the cycle T of the data signal DIN is 400 ps. Delay unit 215 delays the data signal DIN for generating the delay signal D1 such that output terminal Q of D-type flip-flop 218 outputs the clock clk_h. The delay signal D1 lags behind the data signal DIN about 200 ps (T/2).

When the voltage levels of the data signal DIN and delay signal D1 are the same, the voltage level of detection signal E1 is the low voltage level. When the voltage level of the data signal DIN differs from that of the delay signal D1, the voltage level of detection signal E1 is the high voltage level.

During a period P1, the phase of GVCO 217 is reset by the detection signal E1 such that the clock clk_f is generated during a period P2. Therefore, the voltage level of the data signal DIN is obtained when the sampling circuit 22 samples the data signal DIN according to a falling edge of the clock clk_f.

In FIG. 2c, the transmission speed of the data signal DIN is 1.25G bps (billions of bit per second) such that the cycle T of the data signal DIN is 800 ps. Delay unit 215 delays the data signal DIN for generating the delay signal D1. The delay signal D1 lags behind the data signal DIN about 400 ps (T/2). The detection signal E1 is obtained according to the voltage levels of the data signal DIN and the delay signal D1.

During a period P3, D-type flip-flop 218 is reset by the detection signal E1 such that the voltage level of the clock clk_h is high. Because the clock terminal of D-type flip-flop 218 receives the clock clk_f, when the clock clk_f is at a rising edge, the voltage level of the clock clk_h output from the output terminal Q of D-type flip-flop 218 is changed. Thus, the clock clk_h shown as FIG. 2c is obtained.

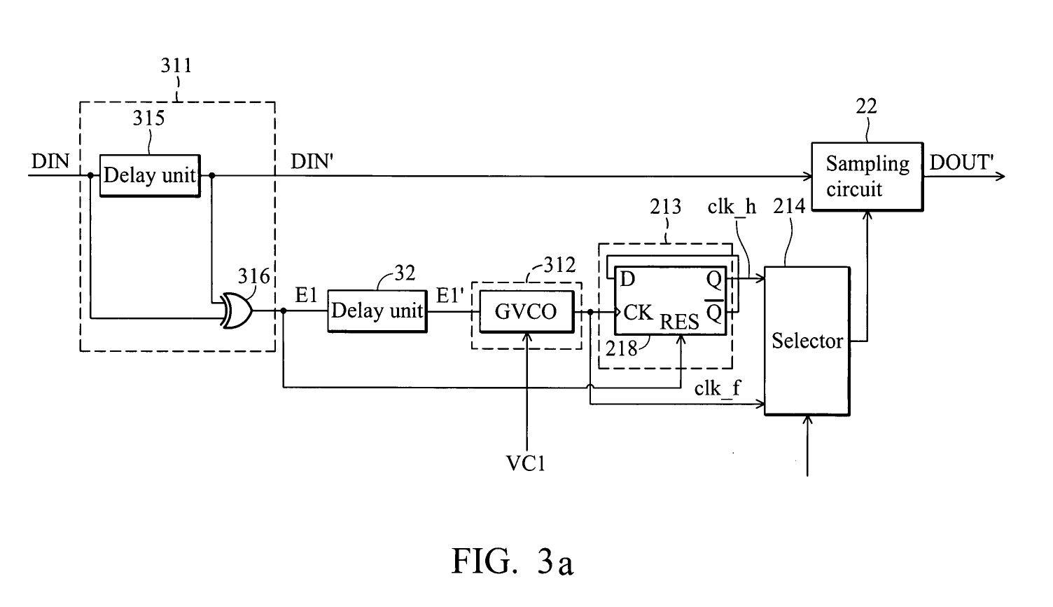

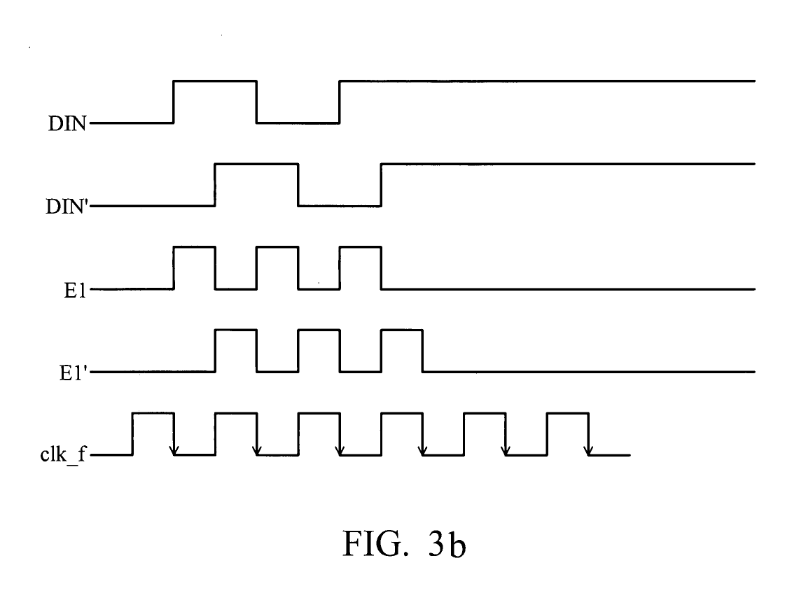

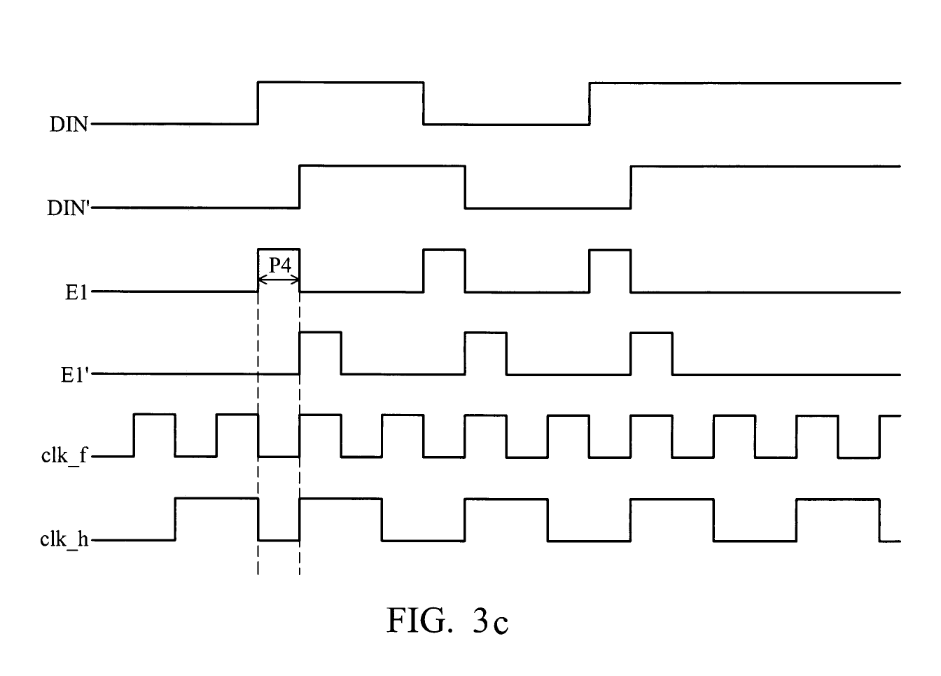

FIG. 3a is a schematic diagram of another exemplary embodiment of a clock recovery circuit. FIG. 3a is similar to the FIG. 2a except that the data signal DIN is delayed by a delay unit 315 for generating a delayed data signal DIN′ and a delay unit 32 is coupled between an edge detector 311 and an oscillator 312. Delay unit 32 delays the detection signal E1 to generate a delayed detection signal E1′.

Oscillator 212 controls the phase of the clock clk_f according to the detection signal E1′. Frequency divider 213 is reset by the detection signal E1. Sampling circuit 22 samples the data signal DIN′ according to a signal output from selector 214 for generating a response signal DOUT′ synchronized with the data signal DIN′.

FIGS. 3b and 3c are timing diagrams of the clock recovery shown in FIG. 3a. In FIG. 3b, the transmission speed of the data signal DIN is 2.5G bps (billions of bit per second) such that the cycle T of the data signal DIN is 400 ps. Delay unit 315 delays the data signal DIN for generating the data signal DIN′ The data signal DIN′ lags behind the data signal DIN by about 200 ps (T/2).

Delay unit 32 delays the detection signal E1 to generate the detection signal E1′. The detection signal E1′ lags behind the detection signal E1 by about 200 ps (T/2). GVCO 212 outputs the clock clk_f according to the detection signal E1′. Since the data signal DIN′ is sampled by sampling circuit 22, the data signal DIN′ is obtained according to a falling edge of the clock clk_f.

In FIG. 3c, the transmission speed of the data signal DIN is 1.25 Gbps (billions of bit per second) such that the cycle T of the data signal DIN is 800 ps. Delay unit 315 delays the data signal DIN for generating the data signal DIN′ The data signal DIN′ lags behind the data signal DIN by about 200 ps. Delay unit 32 delays the detection signal E1 for generating the detection signal E1′. The detection signal E1′ lags behind the detection signal E1 by about 200 ps.

In a period P4, D-type flip-flop 218 is reset by the detection signal E1 such that the voltage of the clock clk_h is the low voltage level. Since the clock terminal CK of D-type flip-flop 218 receives the clock clk_f, when the clock clk_f is at a rising edge, the voltage level of the clock clk_h output from the output terminal Q of D-type flip-flop 218 is changed. Thus, the clock clk_h shown as FIG. 3c is obtained.

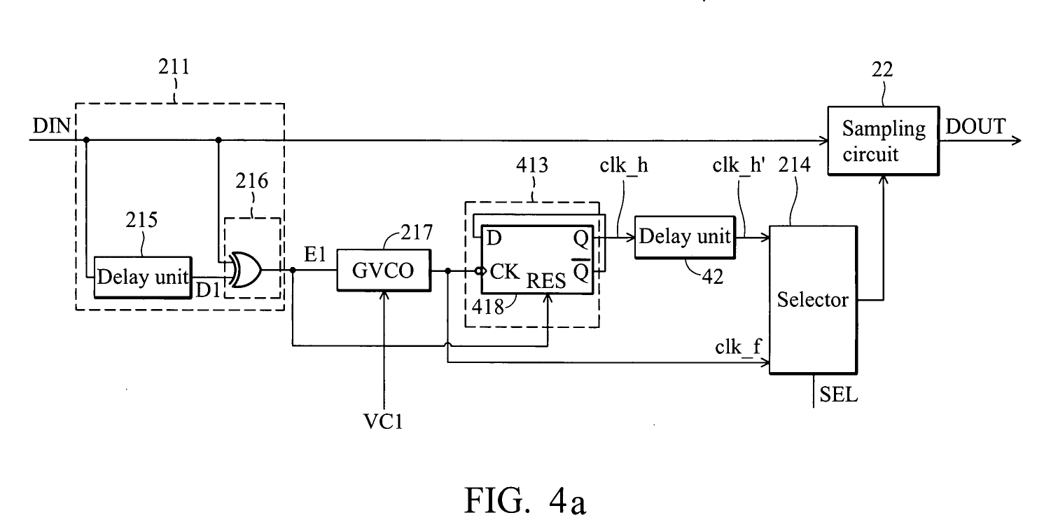

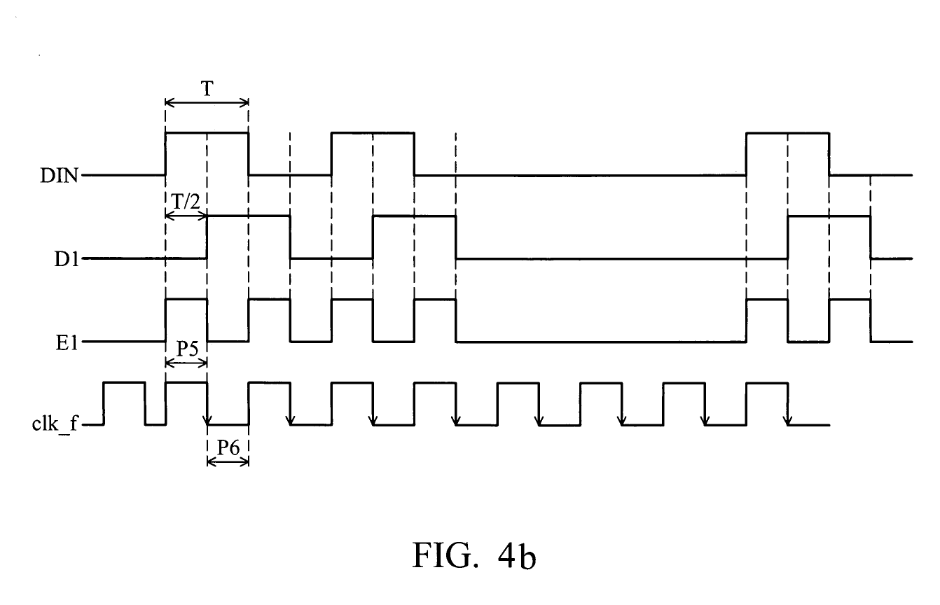

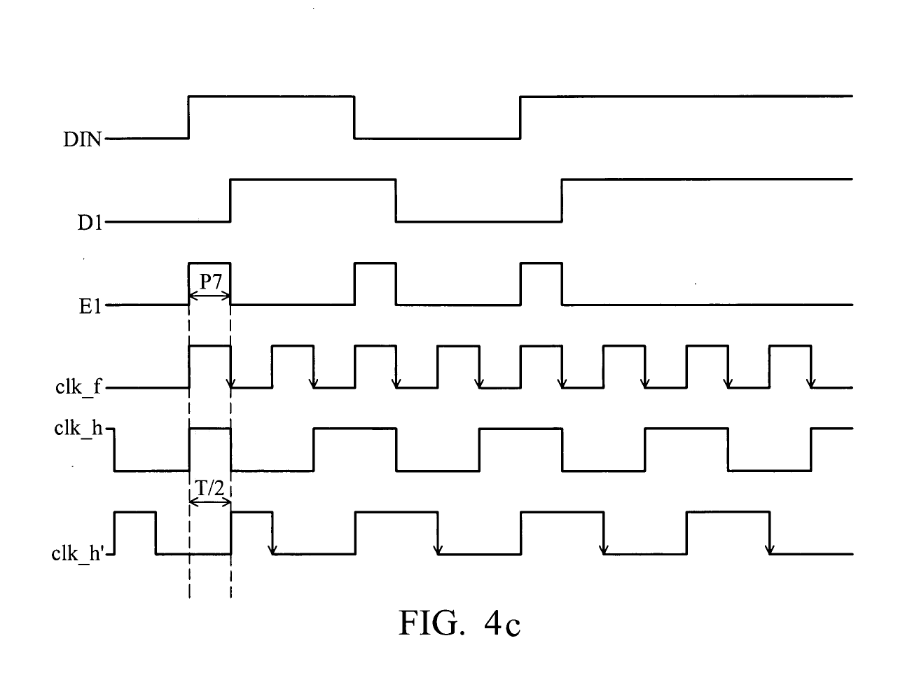

FIG. 4a is a schematic diagram of another exemplary embodiment of a clock recovery circuit. FIG. 4a is similar to the FIG. 2a except that the D-type flip-flop 418 differs from the D-type flip-flop 218. When the logic level of the clock clk_f is transformed from the high logic level into the low logic level, D-type flip-flop 418 is triggered such that the output terminal Q of D-type flip-flop 418 outputs a signal received by the data input terminal D of D-type flip-flop 418.

Additionally, a delay unit 42 coupled between frequency divider 413 and selector 214 delays the clock clk_h to generate a clock clk_h′.

FIGS. 4b and 4c are timing diagrams of the clock recovery shown in FIG. 4a. In FIG. 4b, the transmission speed of the data signal DIN is 2.5 Gbps (billions of bit per second) such that the cycle T of the data signal DIN is 400 ps. Delay unit 215 delays the data signal DIN for generating the delay signal D1. The delay signal D1 lags behind the data signal DIN by about 200 ps.

When the voltage levels of the data signal DIN and the delay signal D1 are the same, the voltage level of the detection signal E1 is low. When the voltage level of the data signal DIN differs from that of the delay signal D1, the voltage level of the detection signal E1 is high.

In period P5, GVCO 217 is reset by the detection signal E1 such that the clock clk_f is generated in period P6. Therefore, the voltage level of the data signal DIN is obtained according to a falling edge of the clock clk_f

In FIG. 4c, the transmission speed of the data signal DIN is 1.25 Gbps such that the cycle T of the data signal DIN is 800 ps. Delay unit 215 delays the data signal DIN for generating the delay signal D1. The delay signal D1 lags behind the data signal DIN by about 200 ps. The detection signal E1 is obtained according to the voltage levels of the data signal DIN and the delay signal D1.

In period P7, D-type flip-flop 418 is reset by the detection signal E1 such that the voltage level of the clock clk_h is high. Since the clock terminal CK of D-type flip-flop 418 receives the clock clk_f, when the clock clk_f is at a falling edge, the voltage level of the clock clk_h output from the output terminal Q of D-type flip-flop 418 is changed. Therefore, the clock clk_h shown as FIG. 4c is obtained.

Since a delay unit 42 delays the clock clk_h to generate the clock clk_h′, the clock clk_h′ lags behind the clock clk_h about 400 ps. Sampling circuit 22 samples the data signal DIN and outputs a normal voltage level according to a falling edge of the clock clk_h′.

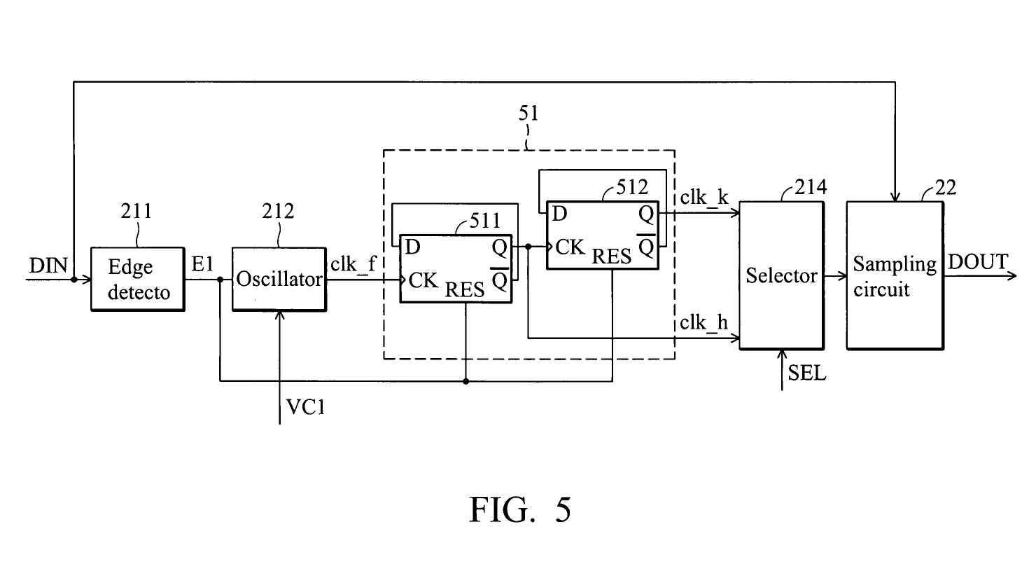

FIG. 5 is a schematic diagram of another exemplary embodiment of a clock recovery circuit. FIG. 5 is similar to the FIG. 2a except that a frequency divider 51 receives the detection signal E1 and the clock clk_f. Frequency divider 51 processes the clock clk_f to generate the clocks clk_h and clk_k. The detection signal E1 resets frequency divider 51.

In this embodiment, frequency divider 51 comprises D-type flip-flops 511 and 512 for generating the clocks clk_h and clk_k. Therefore, the frequency of the clock_h is double that of clock_k and the frequency of the clock_f is double that of clock_h.

D-type flip-flop 511 comprises a data input terminal D, a clock terminal CK receiving the clock clk_f, a reset terminal RES receiving the detection signal E1, an output terminal Q outputting the clock clk_h, and an inverse output terminal Q coupled to the data input terminal D.

D-type flip-flop 512 comprises a data input terminal D, a clock terminal CK receiving the clock clk_h, a reset terminal RES receiving the detection signal E1, an output terminal Q outputting the clock clk_k, and an inverse output terminal Q coupled to the data input terminal D.

Because the clock generator generates clocks with various frequencies, a sampling circuit receives clocks, which have been output from the clock generator and synchronized with a data signal, and detects the phase of the data signal. Additionally, the delay units shown in FIGS. 3 and 4 can be added in the clock recovery circuit shown in FIG. 5.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A clock generator, comprising:
a edge detector generating a detection signal according to an edge of a data signal;
an oscillator generating a first clock according to a control signal and controlling the phase of the first clock according to the detection signal;
a frequency divider processing the first clock to generate a second clock and reset by the detection signal; and
a selector selectively output the first clock or the second clock according to an external signal.

2. The clock generator as claimed in claim 1, wherein the edge detector comprises:
a delay unit delaying the data signal to generate a delay signal; and
a processor controlling a voltage level of the detection signal according to the data signal and the delay signal, wherein the voltage level of the detection signal is at a first voltage level when a voltage level of the data signal is equal to that of the delay signal and the voltage level of the detection signal is at a second voltage level when the voltage level of the data signal differs from that of the delay signal.

3. The clock generator as claimed in claim 2, wherein the processor is a XOR gate.

4. The clock generator as claimed in claim 1, wherein the frequency divider comprises a D-type flip-flop.

5. The clock generator as claimed in claim 4, wherein the D-type flip-flop comprises a data input terminal, a clock terminal receiving the first clock, a reset terminal receiving the detection signal, an output terminal providing the second clock and an inverse output terminal coupled to the data input terminal.

6. The clock generator as claimed in claim 5, wherein the D-type flip-flop is triggered when a voltage level of the first clock is transformed from a first voltage level into a second voltage level.

7. The clock generator as claimed in claim 1, further comprising a delay circuit for delaying the detection signal, wherein the oscillator generates the first frequency according to the delayed detection signal.

8. The clock generator as claimed in claim 1, further comprising a delay circuit for delaying the second clock, wherein the selector outputs the first clock or the delayed second clock according to the external signal.

9. The clock generator as claimed in claim 8, wherein the frequency divider comprises a D-type flip-flop.

10. The clock generator as claimed in claim 9, wherein the D-type flip-flop comprises a data input terminal, a clock terminal receiving the first clock, a reset terminal receiving the detection signal, an output terminal providing the second clock and an inverse output terminal coupled to the data input terminal.

11. The clock generator as claimed in claim 10, wherein the D-type flip-flop is triggered when a voltage level of the first clock is transformed from a second voltage level into a first voltage level.

12. The clock generator as claimed in claim 1, wherein frequency of the first clock is double that of the second clock.

13. The clock generator as claimed in claim 1, wherein the selector is a multiplexer.

14. A clock recovery circuit, comprising:
an edge detector generating a first detection signal according to an edge of a data signal;
an oscillator generating a first clock according to a control signal and controlling phase of the first clock according to the first detection signal;
a frequency divider processing the first clock to generate a second clock and reset by the detection signal;
a selector selectively outputting the first clock or the second clock according to an external signal; and
a sampling circuit sampling the data signal according to a signal output from the selector.

15. The clock recovery circuit as claimed in claim 14, wherein the sampling circuit is a D-type flip-flop.

16. The clock recovery circuit as claimed in claim 14, further comprising:
a phase/frequency detector outputting a second detection signal according to the difference between a reference frequency and a feedback signal;
a charge pump receiving the second detection signal to generate a charge/discharge signal;
a low-pass filter filtering a high frequency element of the charge/discharge signal to generate the control signal; and
a frequency generator generating the feedback signal according to the control signal and controlling frequency of the feedback signal according to a reference voltage.

17. The clock recovery circuit as claimed in claim 14, wherein the edge detector comprises:
a delay unit delaying the data signal to generate a delay signal; and
a processor controlling a voltage level of the detection signal according to the data signal and the delay signal, wherein the voltage level of the detection signal is at a first voltage level when a voltage level of the data signal is equal to that of the delay signal and the voltage level of the detection signal is at a second voltage level when the voltage level of the data signal differs from that of the delay signal.

18. The clock recovery circuit as claimed in claim 14, wherein the processor is a XOR gate.

19. The clock recovery circuit as claimed in claim 14, wherein the frequency divider comprises a D-type flip-flop.

20. The clock recovery circuit as claimed in claim 19, wherein the D-type flip-flop comprises a data input terminal, a clock terminal receiving the first clock, a reset terminal receiving the first detection signal, an output terminal providing the second clock and an inverse output terminal coupled to the data input terminal.

21. The clock recovery circuit as claimed in claim 20, wherein the D-type flip-flop is triggered when a voltage level of the first clock is transformed from a first voltage level into a second voltage level.

22. The clock recovery circuit as claimed in claim 16, further comprising a delay circuit for delaying the first detection signal, wherein the oscillator generates the first frequency according to the delayed first detection signal.

23. The clock recovery circuit as claimed in claim 16, further comprising a delay circuit for delaying the second clock, wherein the selector outputs the first clock or the delayed second clock according to the external signal.

24. The clock recovery circuit as claimed in claim 23, wherein the frequency divider comprises a D-type flip-flop.

25. The clock recovery circuit as claimed in claim 24, wherein the D-type flip-flop comprises a data input terminal, a clock terminal receiving the first clock, a reset terminal receiving the second detection signal, an output terminal providing the second clock and an inverse output terminal coupled to the data input terminal.

26. The clock recovery circuit as claimed in claim 25, wherein the D-type flip-flop is triggered when a voltage level of the first clock is transformed from a second voltage level into a first voltage level.

27. The clock recovery circuit as claimed in claim 16, wherein the frequency of the first clock is double that of the second clock.

28. The clock recovery circuit as claimed in claim 16, wherein the selector is a multiplexer.

29. A clock generator, comprising:
an edge detector generating a detection signal according to an edge of a data signal;
an oscillator generating a first clock according to a control signal and controlling phase of the first clock according to the detection signal;
a frequency divider processing the first clock to generate a second clock and a third clock and reset by the detection signal; and
a selector selectively outputting the second clock or the third clock according to an external signal.

30. The clock generator as claimed in claim 29, wherein the edge detector comprises:
a delay unit delaying the data signal to generate a delay signal; and
a processor controlling a voltage level of the detection signal according to the data signal and the delay signal, wherein the voltage of the detection signal is at a first voltage level when a voltage level of the data signal is equal to that of the delay signal and the voltage of the detection signal is at a second voltage level when the voltage level of the data signal differs from that of the delay signal.

31. The clock generator as claimed in claim 30, wherein the processor is a XOR gate.

32. The clock generator as claimed in claim 29, wherein the frequency divider comprises:
a first D-type flip-flop processing the first clock to generate the second clock; and
a second D-type flip-flop processing the second clock to generate the third clock.

33. The clock generator as claimed in claim 32, wherein the first D-type flip-flop comprises a first data input terminal, a first clock terminal receiving the first clock, a first reset terminal receiving the detection signal, an first output terminal providing the second clock and an first inverse output terminal coupled to the first data input terminal and wherein the second D-type flip-flop comprises a second data input terminal, a second clock terminal receiving the second clock, a second reset terminal receiving the detection signal, an second output terminal providing the third clock and an second inverse output terminal coupled to the second data input terminal.

34. The clock generator as claimed in claim 33, wherein the first D-type flip-flop is triggered when a voltage level of the first clock is transformed from a first voltage level into a second voltage level and wherein the second D-type flip-flop is triggered when a voltage level of the second clock is transformed from the first voltage level into the second voltage level.

35. The clock generator as claimed in claim 29, further comprising a delay circuit for delaying the detection signal, wherein the oscillator generates the first frequency according to the delayed detection signal.

36. The clock generator as claimed in claim 29, wherein the frequency of the first clock is double that of the second clock and wherein the frequency of the second clock is double that of the third clock.

37. The clock generator as claimed in claim 29, wherein the selector is a multiplexer.

38. A clock recovery circuit, comprising:
an edge detector generating a first detection signal according to an edge of a data signal;
an oscillator generating a first clock according to a control signal and controlling phase of the first clock according to the first detection signal;
a frequency divider processing the first clock to generate a second clock and a third clock and reset by the detection signal;
a selector selectively outputting the second clock or the third clock according to an external signal; and
a sampling circuit sampling the data signal according to a signal output from the selector.

39. The clock recovery circuit as claimed in claim 38, wherein the sampling circuit is a D-type flip-flop.

40. The clock recovery circuit as claimed in claim 38, further comprising:
a phase/frequency detector outputting a second detection signal according to the difference between a reference frequency and a feedback signal;
a charge pump receiving the second detection signal to generate a charge/discharge signal;
a low-pass filter filtering a high frequency element of the charge/discharge signal to generate the control signal; and
a frequency generator generating the feedback signal according to the control signal and controlling frequency of the feedback signal according to a reference voltage.

41. The clock recovery circuit as claimed in claim 38, wherein the edge detector comprises:
a delay unit delaying the data signal to generate a delay signal; and
a processor controlling a voltage level of the detection signal according to the data signal and the delay signal, wherein the voltage of the detection signal is at a first voltage level when a voltage level of the data signal is equal to that of the delay signal and the voltage of the detection signal is at a second voltage level when the voltage level of the data signal differs from that of the delay signal.

42. The clock recovery circuit as claimed in claim 41, wherein the processor is a XOR gate.

43. The clock recovery circuit as claimed in claim 38, wherein the frequency divider comprises:
a first D-type flip-flop processing the first clock to generate the second clock; and
a second D-type flip-flop processing the second clock to generate the third clock.

44. The clock recovery circuit as claimed in claim 43, wherein the first D-type flip-flop comprises a first data input terminal, a first clock terminal receiving the first clock, a first reset terminal receiving the detection signal, an first output terminal providing the second clock and an first inverse output terminal coupled to the first data input terminal and wherein the second D-type flip-flop comprises a second data input terminal, a second clock terminal receiving the second clock, a second reset terminal receiving the detection signal, an second output terminal providing the third clock and an second inverse output terminal coupled to the second data input terminal.

45. The clock recovery circuit as claimed in claim 44, wherein the first D-type flip-flop is triggered when a voltage level of the first clock is transformed from a first voltage level into a second voltage level and wherein the second D-type flip-flop is triggered when a voltage level of the second clock is transformed from the first voltage level into the second voltage level.

46. The clock recovery circuit as claimed in claim 40, further comprising a delay circuit for delaying the first detection signal, wherein the oscillator generates the first frequency according to the delayed first detection signal.

47. The clock recovery circuit as claimed in claim 40, wherein the frequency of the first clock is double that of the second clock and wherein the frequency of the second clock is double that of the third clock.

48. The clock recovery circuit as claimed in claim 40, wherein the selector is a multiplexer.
